(19) United States
(12) Patent Application Publication
(10) Pub. No.: US 2013/0122475 A1
(43) Pub. Date: May 16, 2013

(54) LEARNING CENTER REGULATOR AND METHOD OF OPERATING SAME

(71) Applicant: Kimberly Regan Schoenfeldt, Reno, NV (US)

(72) Inventor: Kimberly Regan Schoenfeldt, Reno, NV (US)

(21) Appl. No.: 13/678,534

(22) Filed: Nov. 15, 2012

Related U.S. Application Data
(60) Provisional application No. 61/559,918, filed on Nov. 15, 2011.

(51) Int. Cl. G09B 29/00

(52) U.S. Cl. CPC G09B 29/00
USPC 434/238

(57) ABSTRACT

The invention could be a learning center regulator and methodology for operating same, the learning center regulator could comprise a board having one or more learning center indicia used to respectively represent one or more learning centers, proximate to each said learning center indicia is a one or more attachment means for reversibly engaging one or more student identifiers; one or more student identifiers, each student identifier is assigned to a respective student that participates at one or more learning centers; wherein the student identifier connects to the one of the attachment means proximate to the learning center icon for that learning center that the student has selected to attend.

### STATEMENT REGARDING FEDERALLY SPONSORED RESEARCH OR DEVELOPMENT

Not Applicable.

### REFERENCE TO A “MICROFICHE APPENDIX”

Not Applicable.

### ENTITY STATUS

Applicant claims small entity status.

### FIELD OF THE INVENTION

The present invention relates to methods and apparatuses used in play-based learning center education. More particularity to those methods and apparatuses that increases student participation in selection of play-based learning center activities while providing the educator with an ability to guide student participation as necessary to meet the goals of the educational program to promote play-based learning in a developmentally appropriate manner.

### BACKGROUND

One trend in modern schooling may be the increased implementation of developmentally appropriate educational practices through the use of play-based learning centers over the traditional, unilateral or direct, educator-to-student instruction at preschool and elementary school levels. The play-based learning center education can be seen as generally following a teaching philosophy known as the Reggio Emilio Approach, which generally encompasses the principals of respect, responsibility, and community through exploration and discovery based on interests of children as they substantially engage a generally self-guided curriculum substantially utilizing a continuous cycle of design, documentation and discourse in the Reggio Approach. This approach may be premised on the observation that children, through their curiosity and primal need to learn, can make appropriate education choices based on their current skill sets and level of learning.

The educators wishing to affect this type of educational curriculum may use differentiated instruction (e.g., accomplished through the use of play-based learning centers) to substantially introduce educational provocation into students' learning environments that generally inspires the students to explore presented subject matter using their own interests as a motivational means for learning. Accordingly, as students simultaneously engage and interact with the play-based learning centers, they generally begin to develop and obtain various skills and abilities as sponsored by the play-based learning centers. Students will continue to visit those play-based learning centers until they have attained the skills (as sponsored by the particular play-based learning center) that they need to move on to another level learning center or another level of the learning center. As a result, the play-based learning center education is generally seen as fostering a greater development of the student's social, emotional, physical, cognitive, language, and aesthetic abilities than is generally provided by traditional educational protocols. Educators, as they facilitate this type of learning through play-based learning centers, continuously monitor the students' progress and evolve the skill objectives of a given learning center based on students' engagement, mastery, and inquiry of the skill objectives.

These learning center-based educational interactions can create a learning environment of mutuality and shared ownership by the students (of the learning centers). Associated with this sense of shared ownership is the development of the student's autonomy and self-regulation, social support, and positive feelings. This development of student autonomy more readily takes into account a student's individual learning style and may also give the student an opportunity to explore his or her learning environment (more so than could generally be developed in the traditional educator-to-student discourse-based education) in a hands-on manner within a developmentally appropriate and structured environment. In requiring students to make choices regarding their educational curriculum that fosters their “ownership” in their education, students further learn how to self-regulate and prioritize their learning time, both of which leads to the student's self-empowerment, increased engagement and time on-task, and decreased behavior challenges (that otherwise occurred as a result of boredom).

In allowing the student to take a guided lead in their own education, the learning center educators substantially act as facilitators providing materials and guidance; planning discussions, activities, demonstrations; and assessing the students' activities and mastery of content. Using state and national standards to ensure that the standards and developmental needs of children are meet, the educators generally design learning centers and plan their usage to teach the respective students targeted skills and help them reach objectives in a sequential progression wherein one set of skills and objectives builds upon an earlier achieved set(s) of skills and objectives (e.g., resulting in a “scaffolded” education.) This approach also mirrors the developmental psychology of children wherein children ordinarily learn through this scaffolding behavior (e.g., acquire and build their knowledge base in successive stages) and the best way to for a child to learn therefor is to foster this play-type learning engagement in education.

An example of how the play-based learning center education provides for scaffolding in this progressive or successive learning is seen in the block play-based learning center. Participation at this play-based learning center allows the student, through play block manipulation, to progress through five distinct stages of learning through block manipulation and obtained associated skills. In addition to this natural progression of learning through block play, the play-based learning is dynamic in that the educator can further manipulate, throughout the course of the curriculum, the learning center theme or its targeted skill sets to substantially establish a whole new meaning to the block learning center, which may promote learning of additional skills. These educator-selected changes may include altering initial learning center themes and changing targeted skills to follow an sequential pattern of learning to generally help the student continually obtain progressive desired skill sets that meet set objectives of curriculum

In allowing students to make choices in their curriculum, other benefits are realized, in that students: are empowered to take responsibility for their learning and behavior therein; are more likely to be engaged in learning; become negotiators in their curriculum; become inquirers of learning; obtain critical thinking skills; attain required standards/skills; become autonomous; make friends and develop social relationships; are empowered to be responsible citizens and family members; and embrace a love of learning. They further obtain enhanced skills in the areas of self-regulation, prediction; problem solving; planning; focused attention; language and vocabulary building; social interaction; and metacognition. Students so engaged in such structured choice based curriculum are also more skilled in reading and mathematics in the later grades.

In addition to managing the play-based learning centers and supervising the students engagement with the learning centers, the educator generally needs to be a documentarian and record student data through observation and questioning students and their exchanges with each other and the environment (e.g., verbal, physical, visual, etc) as fostered by the learning centers to be able to process the wealth of student information and data so generated by this learning center program. Such management is generally needed to evaluate student progress and appropriately manage the students' education. Such recordings are referred to as authentic assessment in taking anecdotal notes and collecting anecdotal artifacts (notes based on observations, photographs, completed projects, etc.).

In operating such student self-guided educational programs, most educators also realize that children, well, are children. Sometimes children may stay at a learning center for other reasons besides curiosity and primal need to learn. Sometimes, a child may stay at that particular learning center that just because it's more fun to be at that learning center than at other centers (e.g., the student may otherwise ignore other centers to be at their “most” favorite learning center.) Sometimes for a particular child, the activities at a center learning center may be difficult to grasp or engage in, and as such not so much fun, causing that child will ignore that learning center in favor of other learning centers that the child finds more enjoyable. As such, the play-based learning center based-education, while promoting child's self-guided/self-selection of the curriculum, has to be operated with educator oversight/monitoring coupled with gentle intervention, based on developmental knowledge, to ensure the child's success and progress within the parameters of this education program and complying with state and federal mandates. If the educator is not able to properly manage these tasks, the educational capability of the learning centers may be severely impacted and the educational experience for the students involved may under go severe degradation.

As seen above, making such a play-based learning center curriculum function properly and to simultaneously collect anecdotal records for assessment, requires a significant amount of the educator resources (e.g., time, energy, and effort.) One possible solution could be an interactive learning center management system that accommodates student-based guidance/participation in the play-based learning center curriculum while simultaneously reducing some of the educator resources needed to effective monitor and run the play-based learning center selection portion of the curriculum. Such a system could further allow the freed up educator resources to be applied to another areas of play-based learning center curriculum, such as documentation, evaluation, implementation of change at a learning center and the like.

### SUMMARY OF ONE EMBODIMENT OF THE INVENTION

### Advantages of One or More Embodiments of the Present Invention

The various embodiments of the present invention may, but do not necessarily, achieve one or more of the following advantages:
to provide a learning center regulator that allows students to make and record their own choices as which learning center they wish to use in a play-based learning center curriculum;
the ability to have students identify to the educator what choices they have made as which learning center they wish to use in a learning center curriculum;
to provide a blocking device that locks out a student from choosing a learning center that the educator wishes to limit the student attendance or close off entirely to all student participation;
the ability of an educator to self-empower a student by having the student making their own decisions regarding a learning curriculum yet retain the corrective capacity to modify such student decisions if they are made in error;
to provide a regulator for learning centers program that tracks for time period of learning center usage one or more student's selection of learning centers and allows for simultaneous educator input of anecdotal records;
the ability to have students self-regulate their use of play-based learning center to give the educator more time to further optimize the management of classroom environment, to conduct observations of the learning center interaction, to allow the educator to work with smaller groups of students or in a 1:1 ratio, to implement Developmentally Appropriate Practice (DAP) in accordance with state and federal educational standards, to help minimizes student behavioral issues, and the like;
to provide a learning center regulator for learning centers program that enable participating students to record their selection of learning centers and educators to input anecdotal records for later review through various reports by the educator running the learning center program; and
to provide anecdotal records and center-tracking capability to provide specific data generated reports based on developmental and standards-based checklists and rubrics that incorporate state and national standards.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a learning center regulator comprising a board having one or more learning center indicia used to respectively represent one or more learning centers, proximate to each said learning center indicia is a one or more attachment means for reversibly engaging one or more student identifiers; one or more student identifiers, each student identifier is assigned to a respective student that participates at one or more learning centers; wherein the student identifier connects to the one of the attachment means proximate to the learning center icon for that learning center that the student has selected to attend.

One possible embodiment of the invention could be a method or process for operating a learning center regulator comprising of the following steps, but not necessarily in the order shown, providing a learning center regulator comprising of a board that displays a plurality of indicia that includes at least one learning center indicia, the at least one learning center indicia assigned to a respective learning center, and at least one attaching means for reversibly holding a student identifier proximate to the at least one learning center indicia; providing the student identifier, each student identifier being assigned to a respective student participating in an operation of at least one learning center; and attaching by the student of its student identifier to the attaching means for indicating a student-made learning center selection.

Another embodiment of the invention could be a method or process for operating an electronic system facilitating student-made selection of play-based learning centers comprising of the following steps, but not necessarily in the order shown, providing CPU capability for managing one or more operations of one or more play-based learning centers, the CPU capability comprising of at least one server, the server further storing and running software for processing data that is inputted into and stored by the CPU capability, the inputted data is regarding the activities of one or more students at one or more play-based learning centers, the server further connects to one or more user interfaces, the one or more user interfaces, presenting an interactive image showing one or more learning center identifying icons, at least one student space and at least one student identifier, each learning center icon being assigned to a respective play-based learning center, each learning center icon has its own student space proximate to the said learning center icon, each student participating in the one or more operations of the play-based learning centers has a respective student identifier icon; selecting by the student of the play-based learning center that the student wishes to attend; and engaging the electronic interface by the student using the student's student identifier to identify which play-based learning center that the student has chosen to attend.

The above-description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways with multiple and simultaneous ways. Also, it is to be understood that the phraseology and terminology employed herein are for the purpose of description and should not be regarded as limiting.

### BRIEF DESCRIPTION OF THE DRAWINGS

FIG. 1 is substantially an elevation view of one embodiment of regulator of the present invention.

FIG. 2 is substantially an elevation view of one embodiment of recording device of the present invention.

FIG. 3 is substantially an organizational schematic for the componentry for the electronic version of the present invention.

FIG. 4 is substantially a flow chart showing a methodology of operating the invention.

FIG. 5 is substantially showing for an electronic embodiment of the invention a computer touch screen presentation displaying the regulator board.

FIG. 6 is substantially showing for an electronic embodiment of the invention, a hand-held computer screen presentation displaying a regulator board.

FIG. 7 is substantially showing for an electronic embodiment of the invention, a hand-held computer screen presentation displaying a regulator board as organized by individual student.

FIG. 8 is substantially showing for an electronic embodiment of the invention, a hand-held computer screen presentation displaying a regulator board as organized by individual learning center to monitor the center's teaching effectiveness.

FIG. 9 is substantially showing for an electronic embodiment of the invention, a hand-held computer screen presentation showing a regulator board as organized by individual learning center for generating student reports.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention 10 could comprise of a learning center regulator 20 and methodology 200 for empowering students (e.g., preschoolers, children ages three to five years of age) through play-based learning center-based education to allow them to make choices regarding their participation in the education while reducing at the same time the challenge for educators to manage and guide such students as they make such curriculum choices (and learn through playing.) The educator or educator (not shown) could further use the regulator 20 as a classroom management tool to substantially track such decisions and further record when, where, how, and what (e.g., skills/objectives) students are working on in play-based learning centers (not shown) as well as also establish parameters for centers. The regulator 20, as used directly by the educator, may be used to prompt students, or at least support them, in making learning center choices (e.g., to meet such mandated curriculum parameters.) For older students, the educator could use the regulator to redirect those students to repeatedly interact with same learning center per week as needed. The educator could further instruct older students to directly use the regulator 20 to track and record their own progress regarding play-based learning centers they've engaged.

Other benefits provided to educators by regulator usage may include: providing a means for optimizing the management of classroom environment; freeing up educator's time to conduct observations; recording anecdotal notes; completing developmental and skill based checklists; facilitating learning through inquiry; allowing the educator to work with smaller groups of students or in a 1:1 ratio; helping minimize student behavioral issues; fostering in the classroom various Developmentally Appropriate Practices (DAP); and/or encouraging classroom deployment of educational standards associated with a DAP educational approach.

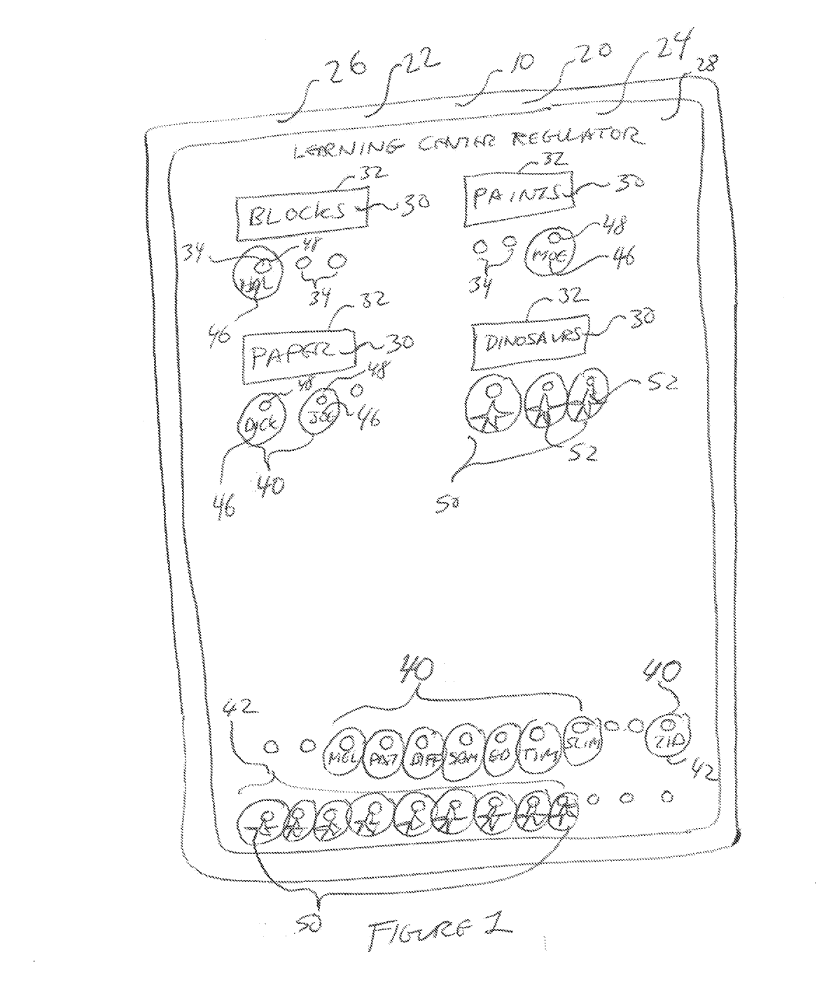

As substantially shown in FIG. 1, one embodiment of the learning center regulator 20, could comprise a board 22 and a set of student identifiers 40. The board 22 (e.g., approximately 3 ft.×4 ft.) could comprise a rectangular sheet 24 made out of suitably resilient material (e.g., cork, cardboard, or the alike) encased by the frame 26 (e.g., wood, aluminum, etc.) to further impart rigidity and durability to the board 22. In one version, the board 22 could be a commercially available standard bulletin board modified for those purposes. A replaceable covering (e.g., butcher paper) or facing 28 could be placed over and reversible secured to the front surface of board 22 by suitable means. The facing 28 could further bear various indicia including learning center indicia 30 to denote or identify spaces or areas on the board 22 as relating or being assigned to respective play-based learning centers (not shown) that make up the educational curriculum.

The learning center indicia 30 could just be self-adhesive labels, cardboard cards 32 (e.g., with slots located on the board being used to hold the cards 32 in place on the board 22) could be used to hold cards 32 in place) and the like bearing markings (e.g., words, graphics and the like) denoting the various learning centers. The words, such as the given title of the respective learning center, could be used with older students, while younger students (Kindergarten/preschool) who may have trouble reading may need graphic-based markings Graphic-based markings could include designs, pictures, drawings, and alike of the various activities that occur in a respective learning center. When graphic-based markings are utilized, the invention 10 could provide the operator with a set of pre-made learning center indicia 30 but the regulator 20 could be readily adaptable to use operator (e.g., educator) created or supplied learning center indicia 30 created from operator-supplied pictures, graphics and the like (e.g., pictures featuring images of the educator's students.) The presentation/organization of such learning center indicia 30 upon the board 22 should be in an easy-to-comprehend and operate format.

Proximate to each respective learning center indicia 30 could be one or more suitable attachment means 34 (e.g., sticky hooks or small key-type hooks and the like) for reversibly holding student identifiers 40 of respective students (each student [not shown] participating in the learning center activities or operation has their individual student identifier 40) that have chosen to participate at particular play-based learning center. Each attachment means 34 could be used to generally denote or identify a personal or student space 36 (e.g. the capacity for one student to attend that particular play-based learning center.) The number of attachment means 34 per learning center indicia 30 could be fixed up to the number of students that could operate at the particular learning center at one time as set by the educator for a particular learning center curriculum.

The student identifier 40 in at least one embodiment could be a tag 42 with each tag 42 being a cardboard disc featuring a engaging means 48 (i.e., a hole near the tag edge to receive a hook of the attachment means 34) for connecting the tag 42 to the attachment means 34. The tag 42 on one side could further feature student identification indicia 46 that would associate the tag 42 with a particular or respective student of the learning center program. While these indicia 46 could be merely a listing of the student's name, for the younger students these indicia 46 could include a picture of the respective younger student to make it easier for the younger student to recognize the student identifier 40 as theirs.

In at least one embodiment, the invention 10 could further comprise of one or more closure markers 50. The closure marker 50 in one embodiment could be a tag 42 bearing suitable warning indicia 52, such a red star or the like. The closure marker 50 could also feature an engaging means 48 (i.e., a hole near the tag edge) to receive an attachment means 34 (e.g., a hook) for connecting the closure marker 50 to the attachment means 34.

The educator could hang such closure markers 50 on attachment means 34 proximate to the learning center indicia 30 to generally indicate or inform the students that a respective student places at the learning center (e.g., whose learning indicia 30 is proximate to the attachment means 34) is closed for that time period and that the student(s) must choose another open place at a play-based learning center. Placement of closure markers 50 at all the attachment means 34 proximate to learning center indicia 30 could be used to indicate that the respective learning center is closed to all students for that time period. In addition to closing (or opening) certain play-based learning centers on specific days, the closure tags 50 could be a learning center control element generally used to reduce the amount of student participation at a particular learning center such as when the students at that learning center are being too noisy, are using the center materials improperly; do not clean up the center properly; and/or the like.

The combination of regulator 20, student identifiers 40, and closure markers 50 could inform students as to which learning center is open for them to participate in as well as allow them to select the learning center they will participate in for that time period. It could also inform the educator as to which students are at which learning center for that respective time period (e.g. student selections of learning centers.)

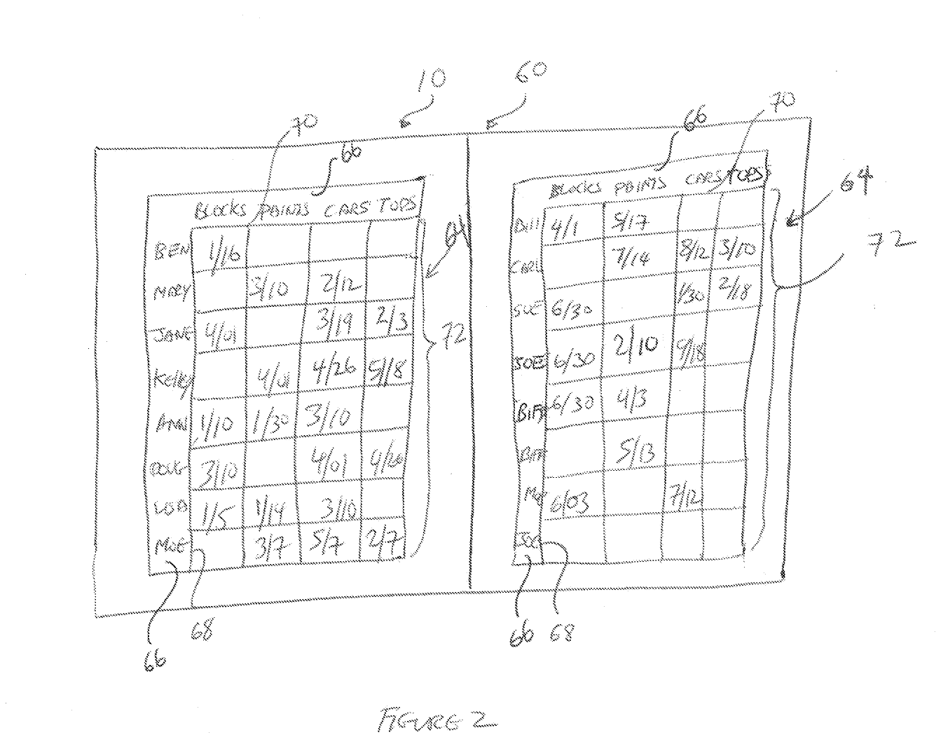

As substantially shown in FIG. 2, the learning center operations information or data should be tracked and recorded by the educator (and in some instances can be tracked by the respective student) on a recording or tracking device 60 to allow the educator to historically monitor which play-based learning centers that the student has participated in through the presentation of the curriculum. Additional features of recording device 60 could allow for the educator to record his or her observations of the students' participation in the various centers, record the progress/or lack of progress that the student has had a learning center; record specific information about skills attained in a given center; complete developmental and standards-based checklists while students engage in a learning center; and the like on the device itself or a synced handheld device. Because the learning is scaffolded, this tracking device 60 could also provide a quick reference ability (e.g., check list) to track which play-based learning centers that the respective student has successfully completed to provide a quick program snapshot for the entire class's overall performance in relation to the curriculum to date and to provide a background means to measure objectively where a particular student's position in relation to the entire class. In more advanced/electronic embodiments, the tracking device 60 could not only be used to store educator notation regarding the operations of the center but further have the capacity to real time record actual student dialogue (sound and video) at the learning centers to allow the educator to later review same to analyze respective student's social emotion and language development.

In one such embodiment, the tracking device 60 could be in one embodiment a document/codex featuring several pages, each page recording indicia on a x-y axial-based grid 64 wherein end spaces 66 on the x-axis 68 of the grid 64 could be accorded names of students in the play-based learning center program while the end spaces 66 on the y-axis 70 of the grid 65 could be assigned names of the various learning center. The grid spaces 72 as located between the axes 68, 70 could be marked with the dates that the respective student successfully engaged a particular learning center.

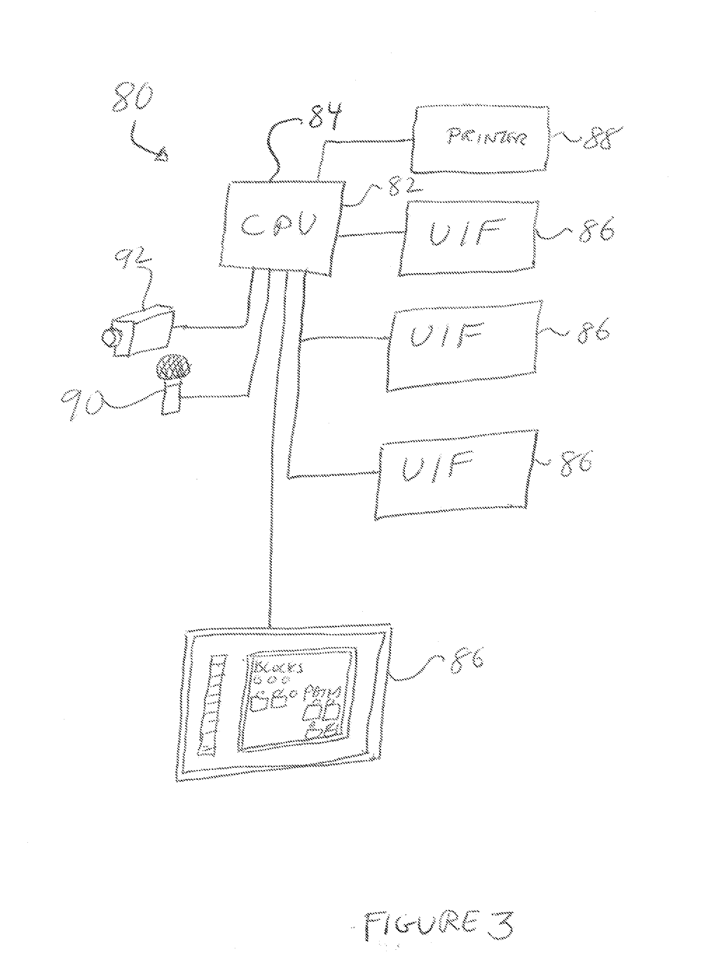

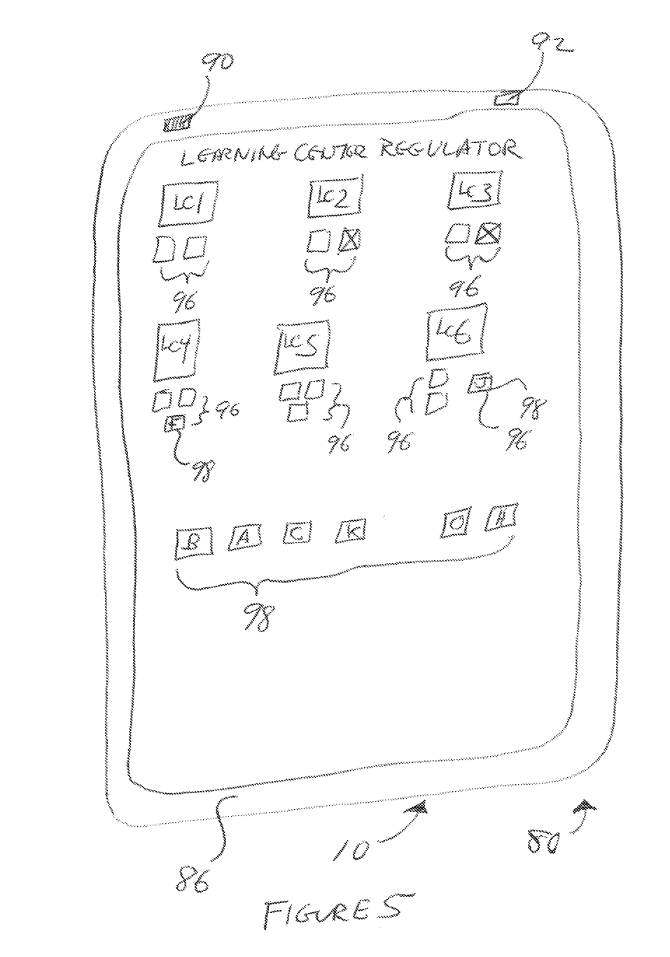

As substantially shown in FIG. 3 at least one embodiment, the regulator 20 could be an electronic system 80 for facilitating student-made selection of play-based learning centers and other play-based learning center educational operations. The electronic management system 80 could comprise of suitable electronic hardware such a CPU capability or capacity 82 in the form of one or more one servers 84, with multiple servers, if used, being networked together. The invention 10, on a smaller scale, could utilize small, hand-held, wireless CPU devices 94 (as substantially shown in FIGS. 5, 6, 7, 8 and 9) CPU capability or capacity 82. The system 80 could further include customary electronic peripherals, such as a user interface 86 (e.g., touch screen) to allow an operator/user (e.g., educator/student) to communicate with the system 80 as well as audio/visual recording devices, printers, remote backup drives, CD/DVD drives; and the like. The system 80 could store, run, or otherwise operate one or more software programs for processing data inputted through the user interface (and other data input portals) as needed to generally manage play-based learning center educational operations.

The educator, securely through a lockout capability, could set the parameters of the software to allow the system to create a visual presentation (via the user interface 86 of the regulator-touch screen) of the regulator 20 or the like wherein the educator selects and organizes various learning center indicia (e.g., icons) on the board to be assigned to the play-based learning centers of the particular educational curriculum. The system 20 could provide the educator with a prearranged set of learning center indicia (e.g., icons) to utilize but could also have the capability of allowing the educator to import into the system 20 such indicia/icons as created elsewhere (e.g. indicia that utilize pictures of the educators own students utilizing the learning centers.) Once the educator has selected a set of learning center identifiers or indicia, the educator may assign specific learning center indicia to a respective learning center. The educator may then assign one or more denoted student spaces (e.g., representing an actual student space at a learning center) to learning center indicia. Once the learning center indicia and student spaces have been selected and properly associated, the educator could organize same into an easy to use and comprehend format.

The educator could access a set of student identifiers icons (e.g., supplied by the invention 10 or created by the educator/other third parties and imported into the system) to substantially assign a respective student identifier (e.g., student identifier icon) to each student. The set of assigned student identifiers icons could be located on the screen proximate to the set of learning center indicia.

The educator could also access a set of one or more closure marker icons provided by the system. The educator could click and drag a closure marker icon to a student space to close that student space to placement of student identifier icons (e.g., reducing the number of spaces/students that could use at a particular play-based learning center.)

Once the educator has setup and organized the visual display representing the board, the student identifiers, the closure marks, and alike as desired, the educator could lock out those parameters via a suitable security protocol. The students, after suitable instruction and possibly follow-on educator-based guidance, could then access the system 80 through the same or different user interface 86. In the system 80, they could be restricted by lockout to the only function(s) they have authority to access, e.g., to click and drag a student identifier icon (e.g., generally their own) to an unoccupied student space of learning center indicia representing a particular play-based learning center that they wish to participate at for the appropriate learning period. The system 80 could through tracking device capability could record student-made learning center selections to provide long term tracking of the student choices as well as provide the educator with an immediate visual indicator of student deployment among the play-based learning centers.

The recording device capability could provide more advanced functionalities such as real life recordation using suitable electronic peripheral devices 88 (e.g., auditory recording device 90 and/or video recording device 92) to substantially capture audio and visual interactions of the students using learning centers for later analysis by the educator as well as for diary or journal functions. This recordation of the educator's observations, data and other information (e.g., real-time written description and checklist documentation) could allow the educator to generate reports based on individual students, by learning centers, by skill sets, by student development and the like.

As substantially shown on FIG. 5, one possible visual presentation of small, hand-held, wireless CPU device 92 could present indicia including one or more learning center indicia 30; each learning center indicia being individually assigned to learning center (not shown); and each learning center indicia 30 could have proximate to it one or more student place indicia 96. The presentation could also show one or more student identifier icons 98 with each student identifier icons 98 being assigned to an individual student (not shown) participating in learning center activities and/or operations. The student could place the cursor (not shown) over the student's student identifier icon 98 and click and drag it over to the unoccupied student space indicia 96 that is not occupied by another student identifier icon 98 or otherwise blocked by the system 80 at a directive by the educator (not shown) to show the student-made learning center selection (as associated with that particular student space indicia 96/learning center indicia 30.)

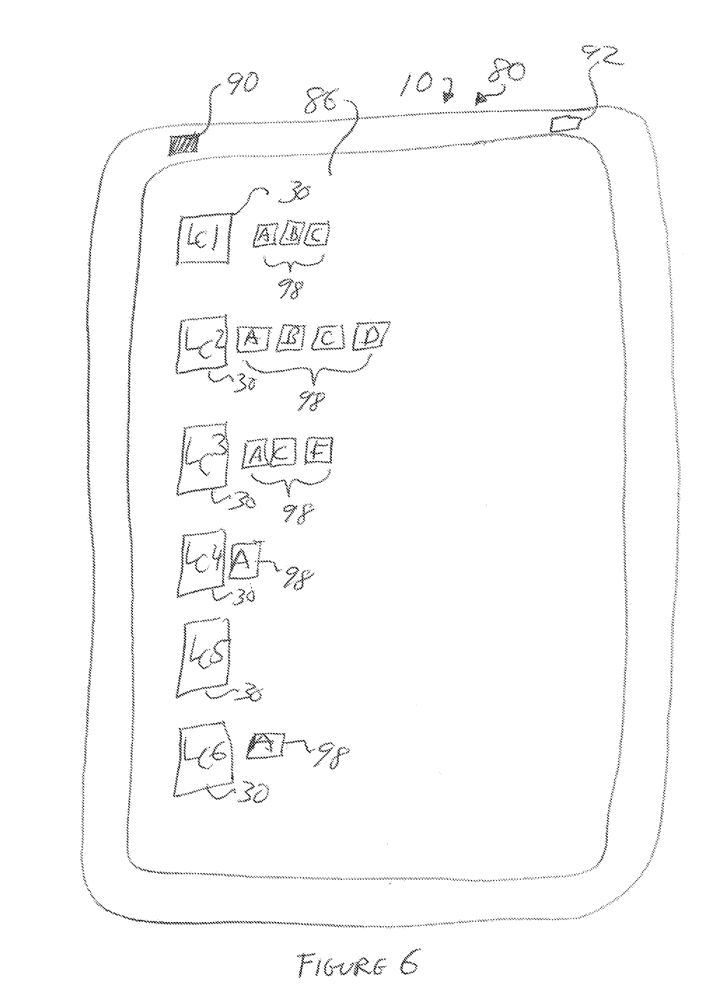

As substantially shown on FIG. 6, another possible visual presentation of small, hand-held, wireless CPU device 92 or other user interface device of the system 80 could again present indicia of learning center indicia 30 and one or more student identifier icons 98. This presentation could show the system's processing of the inputted data from the student-made learning center selections by displaying along with each learning center indicia 30 those student identifier icons 98 of the students (not shown) who have attended that particular learning center (not shown) associated with that learning center indicia 30.

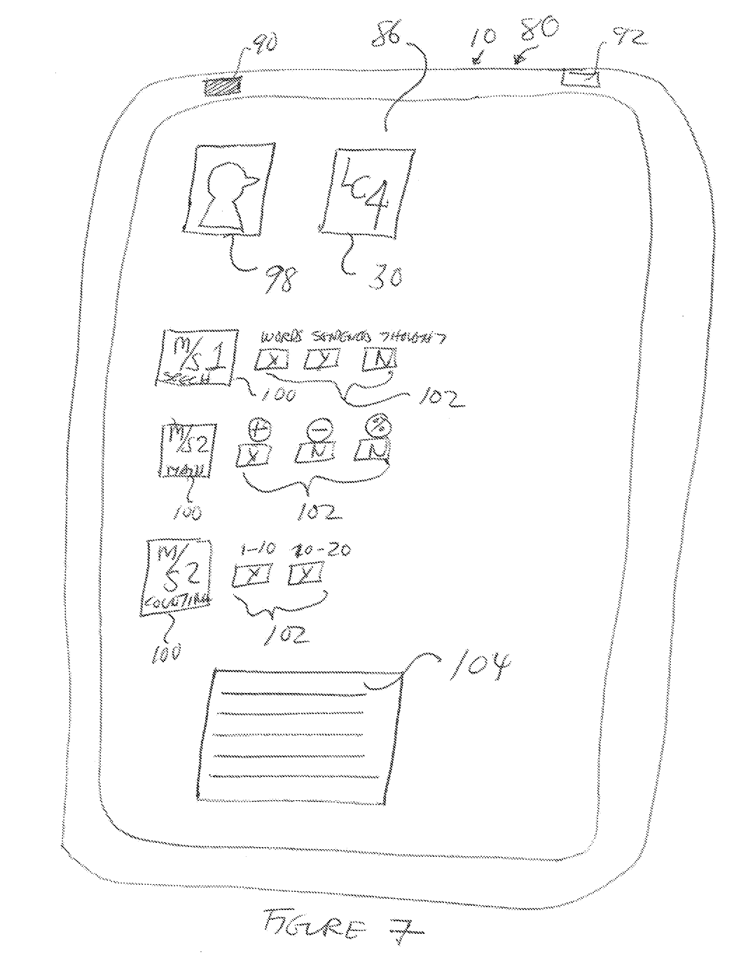

As substantially shown on FIG. 7, yet another possible visual presentation of small, hand-held, wireless CPU device 92 or other user interface device of the system 80 could present a report about an individual student (as identified by the student's student identifier icon 98) for skill set development assessment from the student's participation at a particular learning center (as identified by the assigned learning center indicia 30). The presentation can show a learning center's set of main skills icons 100 along with each main skill's a set of sub skill icons 102. The educator (not shown) can go through each main skills set by checking through the sub skills icons 102 to mark the student as mastering or not yet learning each sub skill. A text box 104 can also be presented for recording additional educator's notes about the student progress.

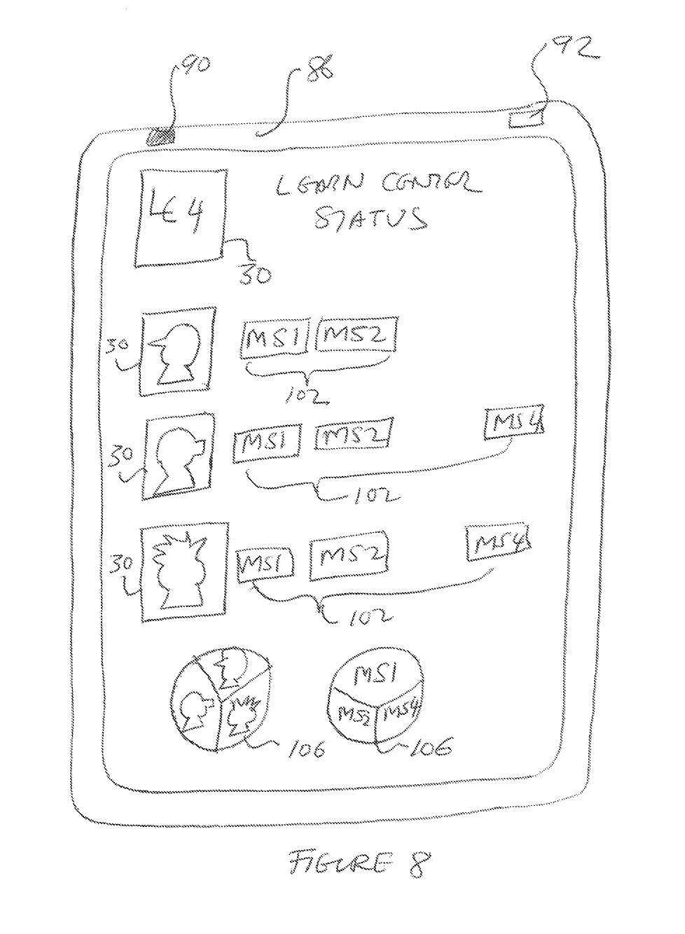

As substantially shown on FIG. 8, still yet another possible visual presentation of small, hand-held, wireless CPU device 92 or other user interface device of the system 80 could show a the effectiveness record for an individual learning center as identified by the learning center indicia 30 associated with that particular learning center (not shown). The presentation could breakdown by each student (as shown by the student's student identifier icon 98) that has attended the particular learning center and the learning center's main skills that the student has mastered by displaying the mastered main skill icons proximate to that student's student identifier icon 98. There could also be graphic summaries 106 of learning center's main skills accomplishment percentage rate; the students individual learning center participation percentage rate and the like that can be used to determine the learning center's effectiveness in achieving teaching its main skills.

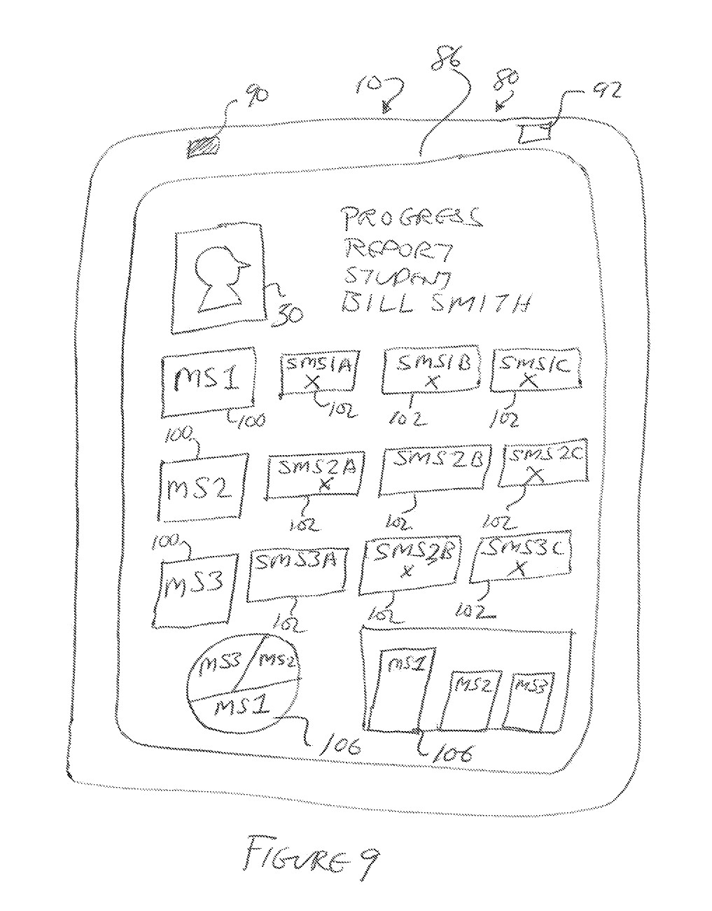

As substantially shown on FIG. 9, and still yet another possible visual presentation of small, hand-held, wireless CPU device 92 or other user interface device of the system 80 could be the overall progress report (e.g., report card) of the student as it relates to the learning center activities to date. The report can be identified by the student's student identifier icon 98 and can be broken down by main skill icons 100. Each main skill icon 100 can have associated with it several sub skills icon 102 showing by suitable markings (e.g., and “X”) whether the student had mastered the individual sub skills. The students overall accomplishments in the main skill icons could also be displayed in graphics summaries 106.

Methodology

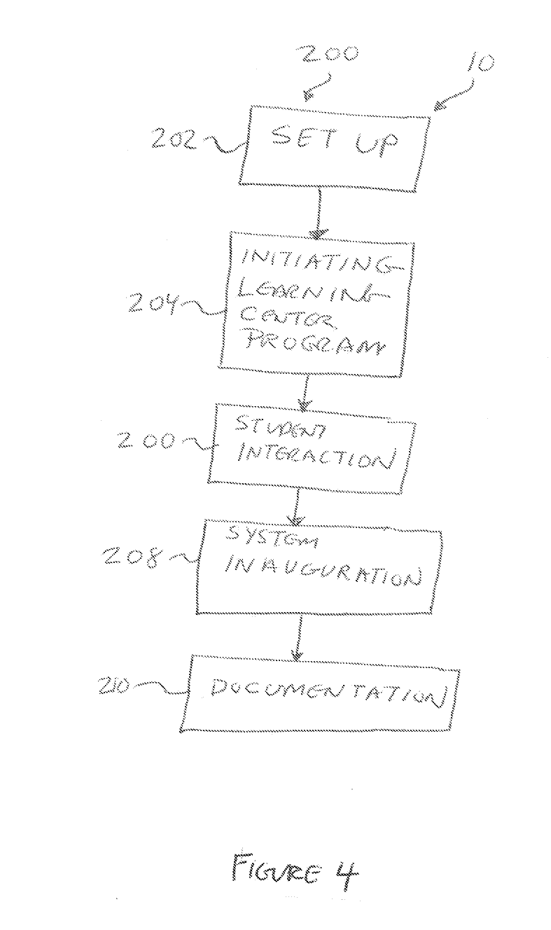

As substantially shown in FIG. 4, the first step of the process 200 of using the invention 10 could be step 202, setting up the play-based learning centers. The implementation of the learning centers-based education for a beginning class could generally require the educator to first plan out each play-based learning center and execute each center. To do this, the educator, while maintaining good knowledge of over state and federal standards for the program, must have/obtain a very solid understanding regarding: childhood development and how that impacts upon, and may facilitate, learning; the stages of learning inherent in each center as designed; the academic and social objectives of each learning center; the dynamics of student participation in the center; how the learning centers enable the student to accomplish those objectives; when the educator must instigate corrective actions must be taken to aid a student; what corrective actions must be taken; and how to implement such corrective actions. Such knowledge is crucial to overall success and management of the learning centers educational program. The overall goal in implementing and using the invention 10 is for the educator to keep in mind is that play-based learning centers should be fun, attractive, developmentally appropriate, continually evolving, and, most of all, encourage learning through play.

Once the requirements and constructs of each play-based learning center is established, the educator could then construct each learning center according to plan. Generally, it should take approximately six (6) weeks of learning center operations for the students to fully respond to the learning centers program and to start their own self-regulated curriculum decisions (e.g., properly engage the regulator.) During the initial six week workup, the educator needs to keep a close monitoring of the student interaction with the regulator (possibly, initially making the choice of centers for the students on startup.) Once this step is substantially completed, the process 200 could proceed to step 204, initiating the program.

During this step 204, initiating the program, the educator, in engaging a class for the first time in the learning centers program, should instruct the class as to what each learning center is and how it is used. Learning centers could be introduced three or four at a time for maximum efficiency. For each play-based learning center, the educator should model (e.g., demonstrate center operations) and allow children to practice how to use materials and follow clean-up procedures. One possible approach is to discuss and role play with students beforehand potential problems of each center and how children should work together to resolve them.

For example: discuss with the children how they should handle a situation at a learning center when one of their classmates left the learning center without cleaning up their mess (failure to put back materials into their proper places.) Cleanup is an opportunity to learn and show knowledge. For example, when putting blocks away by shape and size is a specific math skill. Putting housekeeping items away by shape, color and size is another math skill. Language is required to communicate how things are put away and social relationships are formed as children communicate with one another the various tasks related to putting materials away.

Another example could be to have the educator to discuss with the class what to do when one of their classmates are not using learning center materials appropriately. Role playing (e.g., one child pretending to be the educator and one child pretending to be the “misbehaving” student) is one way to teach children appropriate skills (e.g., every misbehavior being an opportunity to learn an appropriate behavior) when confronted with complex problems such as the scenarios described.

Another initiation aspect could be to have the educator establish with the class an appropriate noise level for each center. This could be initiated by having the educator first play a variety of soft music to set the tone for the noise level in the classroom. The educator could then prompt students (e.g., call them to attention) to make sure they still hear the music when they are playing at a learning center. This should be repeated in order to condition the students and to get all of their attention quickly. This could be accomplished by playing a game utilizing simple attention catchers like the term “Freeze” which, upon hearing it, the child stops doing what they are working on and turn towards the educator. When all children are able to freeze, it may be an opportune time to mark the whole class as being good and placing themselves for a class reward. At the completion of this step, the process 200 could proceed to step 206 student interaction with the play-based learning center.

At step 206, student interaction with the play-based learning center, the educator could initially assign sets of students to respective learning centers and allow the students a first opportunity to practice using a play-based learning center's materials and cleaning up. As one set of students seems to grasp the inner workings of a learning center, the educator should move or rotate that set of students to a new center until all sets of students have been introduced to all of the learning centers. This student rotation provides the students both with educator's direction and initial quality feedback on the learning stations as well as maximizing the education benefit that the class can obtain from the learning centers. Once this step has been substantially completed, the process 200 could proceed to step 208, regulator operations.

In this step 208, regulator operations/system inauguration, the educator could introduce the regulator to the student as well as explain its use and functions to the students. The educator should then introduce the students to their respective previously assigned student identifiers (e.g., student tags). After associating the student identifier/icons with their respective student, the educator could show the class how and when the identifiers/icons should be attached to the regulator for the student selection of learning centers. This instructing includes informing the students, that only one child's student identifier is allowed per hook/per student place indicia. The educator should inform the class about the closure markers/icons and that they indicate, “STOP, the space in that center is closed” and that they cannot use that space to attend a learning center. If the student spaces/attachment means/student place indicia proximate to a particular learning center identifier are already filled/occupied (with another student identifiers/icon or a closure marker/icon) then the student should be made to understand that they cannot play in that play-based learning center at that time. The student will need understand that they have to choose another learning center at which to play. They should be reassured that they will all get a turn to play at all the learning centers. This reassurance should be thorough because the youngest students, at that development age are primarily present-time based and may have a shaky grasp regarding the occurrence of future events.

Also for young students, especially for the preschoolers, having too many choices at the beginning of the program can be daunting. The educator, depending on the number of learning centers initially presented, could at the beginning use the closure marker/icon to generally limit the number of choices initially that are available until students are used to making choices with the regular. As the students become acquainted with making their own learning center decisions using the regulator, the educator could one or more closure tags from the regulator to open up more student spaces at learning centers as well as entire learning centers (and increase student choices.)

After discussing the basic regulator operations with the students, the educator should further discuss with the class various procedures for group interaction with the regulator, such as: what is the number of children allowed to be using the regulator at one time (generally, allow no more than two students at the regulator-the remaining students wanting to use the regulator should form a line proximate to the regulator); what actions should students take when they want to change learning centers during learning center time period.

When educator has determined that the students have received enough instruction; have sufficient understanding of the process; have ample time to practice working in centers and make choices; and are ready to begin choices with the regulator, the educator can initiate use of the regulator by have the individual students place their respective student identifiers/icons on unused attachment means/student place indicia proximate to the learning center indicia that they would wish to attend. During the first few weeks of operation, the educator should review/monitor the student selection process with the regulator at the beginning of the learning center time period to assist students in making learning center decisions as necessary.

As the students become more accustom to using the regulator/system, the educator should move back from direct involvement in the student choice making process and give the students more autonomy as the case may warrant. As this step is substantially completed, the process 200 could proceed to step 210, documentation.

At step 210 documentation, the educator, in order to be able to thoroughly and properly assess the impact of the learning centers upon individual students, should institute recordation of activity at the learning centers. On one level, this could be recordation could the tracking of the learning center operations (identifying which student attended which learning center and when; the students interactions at a respective center at any given time; and the like) through the recording device. On other levels, a simple check-off/tracking sheet attached to a clipboard can allow the young student record their own activities. Each child could have their own clip board with their own check-off/tracking sheet that can be exchanged for a new sheet each week. Check-off/tracking sheet could also be constructed to resemble the organizational format of the regulator so they children associate identifiers/words/icons of the tags and board with the respective learning centers. Children can either track each learning center they attend as they enter or exit the center.

In one version, they could simply place a mark or check by the learning center indicia for the respective learning center they attended. The educator can then monitor center attendance by keeping check-off/tracking sheets in a portfolio binder (one for each child). The educator should also try to meet with each child to encourage that student to try new learning centers. Students (and educators) experience success when children are taught to responsibly document their own learning center activities.

The play-based learning center education also provides a great opportunity to conduct authentic observations and anecdotal records of what children are doing, what skills/objectives they are mastering, quote phrases that articulate skills they are learning, and most importantly to engage in conversations with children to foster learning and challenge them to advance to the next level of thinking For the board-based version of the regulator, the educator could avail herself of audio-visual real time recording of the student's activities with the centers, as well as hand write documentation of the same. In the system management versions, the educator's observations could be entered through the user interface device.

Once the system is fully in place and students understand what expectations are during centers, educators can pull students, individually or in small groups, for ability-based direct instruction and assessment.

### Conclusion

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As the specification and drawings disclose, the invention provides a learning center regulator that allows students to make and record their own choices as which learning center they wish to use in a play-based learning center curriculum that self-empowers a young student by having the student making their own decisions regarding a learning curriculum yet retain the educator's corrective capacity to modify such student decisions if they are made in error.

What is claimed is:

1. A method for operating a learning center regulator comprising of the following steps, but not necessarily in the order shown:
(a) providing a learning center regulator comprising of a board that displays a plurality of indicia that includes at least one learning center indicia, the at least one learning center indicia is assigned to a respective learning center, and at least one attaching means for reversibly holding a student identifier proximate to the at least one learning center indicia;
(b) providing the student identifier, each student identifier being assigned to a respective student participating in an operation of at least one learning center; and
(c) attaching by the student of its student identifier to the attaching means for indicating a student-made learning center selection.

2. The method of claim 1 wherein the indicating a student-made learning center selection further comprises a step of identifying a student-selected learning center by placing the student's student identifier proximate to the learning center indicia assigned to the said student-selected learning center.

3. The method of claim 1 further comprises removing the student identifier from the attaching means to indicate that the student is no longer attending a student-selected learning center.

4. The method of claim 1 further comprises reviewing by an educator of the student-made learning center selection.

5. The method of claim 4 further comprises providing and using a tracking device that is used for recording the student-made learning center selection, wherein the tracking device is separate from learning center regulator.

6. The method of claim 4 wherein the step of reviewing further comprises a step of adjusting by the educator of the student-made learning center selection by reassigning the student to another learning center that the student did not originally select.

7. The method of claim 1 further comprises removing the student identifier by the educator from the attaching means and connecting the student identifier to another attaching means proximate to another learning center indicia assigned to a learning center that the student did not originally select.

8. The method of claim 1 further comprises providing at least one closure marker.

9. The method of claim 8 wherein the providing at least one closure marker further comprises a step of connecting the closure marker to the attachment means by an educator thereby identifying that a student position at the learning center is closed.

10. The method of claim 9 wherein the closed student position is at the leaning center whose assigned learning center indicia is proximate to the attachment means connected to the closure marker.

11. A method for operating an electronic system facilitating student-made selection of play-based learning centers comprising of the following steps, but not necessarily in the order shown:
(a) providing CPU capability for managing one or more operations of one or more play-based learning centers, the CPU capability comprising of at least one server, the server further storing and running software for processing data that is inputted into and stored by the CPU capability, the inputted data is regarding the activities of one or more students at one or more play-based learning centers, the server further connects to one or more user interfaces, the one or more user interfaces, presenting an interactive image showing one or more learning center identifying indicia, at least one student space indicia and at least one student identifier icon, each learning center indicia being assigned to a respective play-based learning center, each learning center indicia has its own student space proximate to the said learning center indicia, each student participating in the one or more operations of the play-based learning centers has a respective student identifier icon;
(b) selecting by the student of the play-based learning center that the student wishes to attend; and
(c) engaging the electronic interface by the student using the student's student identifier icon to identify which play-based learning center that the student has chosen to attend,

12. The method for operating an electronic system of claim 11 wherein using the student's student identifier icon further comprises the step of clicking and dragging the student's student identifier icon to the student space indicia proximate to the learning center indicia representing the play-based learning center that the student has selected to attend.

13. The method for operating an electronic system of claim 11 further comprising selecting the play-based learning center that an educator wants to reduce the number of students that can attend, inputting data about that selection through the interface into the electronic system, the electronic system after processing that data reduces the number of student space indicia proximate to the learning center icon for that educator-selected play-based learning center.

14. The method for operating an electronic system of claim 11 further comprising removing by the student of the student's student identifier icon from the student place indicia indicating that the student is no longer attending the play-based learning center whose learning center indicia was proximate to the said student place indicia.

15. The method for operating an electronic system of claim 11 further comprising moving by an educator of the student identifier icon from the student place indicia for the learning center indicia to another student place indicia associated with another learning center indicia indicating the reassigning of the student to a play-based learning center that the student did not select.

16. The method for operating an electronic system of claim 11 further comprising inputting data by an educator about learning center operations through the interface into the electronic system, the electronic system processing and storing that data for later presentation in a report showing a student's progress in the learning center operations and activities.

17. A learning center regulator comprising:
(a) a board having one or more learning center indicia used to respectively represent one or more learning centers, proximate to each said learning center indicia is a one or more attachment means for reversibly connecting one or more student identifiers;
(b) one or more student identifiers, each student identifier is assigned to a respective student that participates at one or more learning centers;
wherein the student identifier connects to the one of the attachment means proximate to the learning center indicia for that learning center to which the student has selected to attend.

18. The learning center regulator of claim 17 wherein number of attachment means proximate the learning center indicia equals the number of student positions at learning center that is represented by the learning center indicia.

19. The learning center regulator of claim 17 further comprising one or more closure markers, the closure marker connecting to the attachment means to indicate that the said attachment means cannot be used to connect to the student identifier.

20. The learning center regulator of claim 17 further comprising one or more closure markers, the closure marker connecting to the attachment means reduces the number of students that can attend a learning center whose learning center indicia is proximate the said attachment means.
